(19) United States
(12) Patent Application Publication
(10) Pub. No.: US 2024/0133627 A1
(43) Pub. Date: Apr. 25, 2024

(54) AIR DRYER AND METHOD OF USE

(71) Applicant: James Dickey, Santa Rosa, CA (US)

(72) Inventor: James Dickey, Santa Rosa, CA (US)

(21) Appl. No.: 18/381,933

(22) Filed: Oct. 18, 2023

Related U.S. Application Data
(60) Provisional application No. 63/380,310, filed on Oct. 20, 2022.

(51) Int. Cl. F26B 21/00; F26B 9/00

(52) U.S. Cl. CPC F26B 21/001; F26B 9/003

(57) ABSTRACT

An electric dryer designed for drying a bladder or food storage bag, featuring an electric fan enclosed within a housing, and an insert with a nozzle for directing air into the internal volume of the bag. The insert is dimensioned to be inserted into the bag's opening, separating the front and back panels and preventing the bag from folding along its longitudinal axis. The fan is capable of moving between five and fifteen cubic feet of air per minute. The insert may include a projection to prevent the bag from being blown off and is shaped to project at least an inch into the bag. The dryer may also include a base with at least one projection extending at an angle to the axis of the insert. The power line can be configured to couple to a wall outlet or a battery. The dryer may also come as part of a kit, including a tubular member and a flexible elongated tether for connecting the tubular member to the electric dryer.

### CROSS REFERENCE TO RELATED APPLICATION

This application claims benefit from currently pending U.S. Provisional Application No. 63/380,310 titled “Air Dryer and Method of Use” and having a filing date of Oct. 20, 2022, and all of which is incorporated by reference herein.

### FIELD OF THE INVENTION

The present disclosure relates to an electric dryer specifically designed for drying bladders or food storage bags, and more particularly to an electric dryer that utilizes an electric fan and a specially designed insert to facilitate the drying process.

### BACKGROUND OF THE INVENTION

Portable pliable bladders and other food storage bags while very popular for recreational hikers and in military usage, do need to be dried between uses to remove residual water, which if not dried, becomes a media for the growth of molds and mildew.

While forced air dryers have been discloses for this application, they suffer from a larger size and are not portable for taking on multi-day hikes, or the convenience of storing the dryer with the pliable bladder in the same backpack.

Many drying devices are simply frames that can be inserted into the pliable bladder to separate the sides so they can drip dry, but do not speed up during by promoting air circulation, such as U.S. Pat. No. 7,568,673 B2 which issued to J.D. Irvington on Aug. 4, 2009.

US Patent application with publication no. US2021/0254893A1 (Aldrete, S) which published Aug. 19, 2021 and is a continuation in part of U.S. Pat. No. 10,995,987 issued on May 4, 2021, and is incorporated herein by reference, discloses a forced air dryer with larger dimension that the pliable bladder, and hence would not be portable in the sense that it could reasonably be held in or on the same backpack that holds the bladder.

While these devices are intended to for pliable bladders that have a rigid rim 30 attached to a side for opening, other styles of bladders present additional challenges. The pliable bladders are generally formed of two generally rectangular sheets of plastic film or sheets and sealed at the common perimeters to form a front and bag face, with a hose connection at a lower end. A rigid rim 30 may be connected on an upper end of an opposing face, as illustrated in FIG. 14-16.

Another type of pliable bladders 10 are also formed from two layers of flexible plastic film or sheet but are only joined at 3 sides, having a sealable upper common side or top end 12, which is illustrated in FIG. 2A-2B, among others. The common side or top end 12 can be sealed with a clamp or a “zipper type” closure in which front panel 22 of the bladder 10 and back panel 24 provide a matting track 21 and channel 22. Such a projecting linear interior track 21 that is configured to snugly engages with the channel 22 formed between a pair of spaced apart linear projections 23 that extend inward from the opposing side or sheet. The front panel 26 and back panel 28 sides are held apart for the few moments it may take to fill the bladder 10 with water.

It would be desirable to provide a compact, efficient air dryer and a method of use that prevents growth of bacteria, mold, and mildew by facilitating drying the bladder after use. Thorough and regular air drying of bladder can thus extend the useful life and avoid the need to clean or disinfect with harsh chemical.

Another object is to provide such a device with a compact size and powering options renders it a portable to use on camping or backpacking trips, which is the device has low power consumption and is compact relative to a backpack that holds the bladder.

The above and other objects, effects, features, and advantages of the present invention will become more apparent from the following description of the embodiments thereof taken in conjunction with the accompanying drawings.

### BRIEF SUMMARY OF THE INVENTION

In the present innovations, the present disclosure relates to an electric dryer designed for drying a bladder or food storage bag. The dryer includes an electric fan enclosed within a housing, with a power line providing power to the fan. The housing features an insert on the output side of the fan, which includes a nozzle for directing air from the fan into the internal volume of the bladder or food storage bag. The insert can be dimensioned to be inserted into the opening of the bladder or food storage bag, separating the front and back panels and preventing the bag from folding along its longitudinal axis.

The fan can be configured to move between five and twenty-five cubic feet of air per minute. The insert can be semi-rigid and may include a projection to prevent the bladder or food storage bag from being blown off of the insert. The insert can be shaped to project at least an inch into the bladder when inserted. The insert also has an axis, and the dryer includes a base to which the housing is secured. At least one projection extends at an angle to the axis of the insert. The housing includes at least one inlet on the intake side of the fan that allows air into the housing when the fan is on. The projection can have a dome shaped top at the nozzle to direct air flow through the nozzle. The angle can be between 110 and 140 degrees.

The projection may be removably attached to the insert and/or the housing may be detachably secured to the base. The power line can be configured to couple to a wall outlet or a battery. The insert may further include a pair of curvilinear projections that form a generally circular or oval perimeter, each projection in the pair being separated from the other by about 180 degrees about a center of the nozzle. The insert may have a lower inward tapering portion. The housing includes a safety grating on the intake side of the fan and is supported on at least one leg on the intake side of the fan that elevates the housing above the surface when placed on a surface. The disclosure also includes a kit for drying a bladder, which includes the electric dryer, a tubular member configured to open the valve at an end of a drinking hose in fluid communication with the pliable bladder, and a flexible elongated tether for connecting the tubular member to the electric dryer. The tubular member may include a handle with a hole through which the tether may be passed.

Another aspect of such innovations is characterized kit for drying pliable bladder that comprises any such electric dryer, a tubular member configured to open the valve at an end of a drinking hose in fluid communication with the pliable bladder, a flexible elongated tether strap for connecting the tubular member to the electric dryer.

Another aspect of any such innovations are characterized by a process for drying a pliable bladder or food storage bag, the process comprising the steps of providing the electric dryer device and a bladder with an oval opening at an end for filling with potable water, the nozzle having a front opening with a pair of curvilinear projection from a generally circular or oval perimeter, each projection in the pair being separated from the other by about 180 degrees about a center of the nozzle, aligning the projections of the of the front of the nozzle with the opposing edges of the opening at side seams of the bladder, inserting the nozzle into the oval opening at least until upper portion of the projections penetrate beyond oval opening, rotating the nozzle about 90 degrees about the center to enlarge the oval opening such that the nozzle is capable of engaging the bladder such that the weight of the electric dryer is supported by the bladder when the bladder is hanging from a side opposite the opening.

The above and other objects, effects, features, and advantages of the present invention will become more apparent from the following description of the embodiments thereof taken in conjunction with the accompanying drawings.

Aspects and applications of the invention presented here are described below in the drawings and detailed description of the invention. Unless specifically noted, it is intended that the words and phrases in the specification and the claims be given their plain, ordinary, and accustomed meaning to those of ordinary skill in the applicable arts. The inventors are fully aware that they can be their own lexicographers if desired. The inventors expressly elect, as their own lexicographers, to use only the plain and ordinary meaning of terms in the specification and claims unless they clearly state otherwise and then further, expressly set forth the “special” definition of that term and explain how it differs from the plain and ordinary meaning. Absent such clear statements of intent to apply a “special” definition, it is the inventors' intent and desire that the simple, plain and ordinary meaning to the terms be applied to the interpretation of the specification and claims.

Aspects and applications of the invention presented here are described below in the drawings and detailed description of the invention. Unless specifically noted, it is intended that the words and phrases in the specification and the claims be given their plain, ordinary, and accustomed meaning to those of ordinary skill in the applicable arts. The inventors are fully aware that they can be their own lexicographers if desired. The inventors expressly elect, as their own lexicographers, to use only the plain and ordinary meaning of terms in the specification and claims unless they clearly state otherwise and then further, expressly set forth the. Absent such clear statements of intent to apply a “special” definition, it is the inventor's intent and desire that the simple, plain, and ordinary meaning to the terms be applied to the interpretation of the specification and claims.

The inventors are also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventors are fully informed of the standards and application of the special provisions of 35 U.S.C. § 112 (f). Thus, the use of the words “function,” “means” or “step” in the Detailed Description or Description of the Drawings or claims is not intended to somehow indicate a desire to invoke the special provisions of 35 U.S.C. § 112 (f), to define the invention. To the contrary, if the provisions of 35 U.S.C. § 112 (f) are sought to be invoked to define the inventions, the claims will specifically and expressly state the exact phrases “means for” or “step for, and will also recite the word “function” (i.e., will state “means for performing the function of [insert function]”), without also reciting in such phrases any structure, material or act in support of the function. Thus, even when the claims recite a “means for performing the function of . . . ” or “step for performing the function of . . . ,” if the claims also recite any structure, material or acts in support of that means or step, or that perform the recited function, then it is the clear intention of the inventors not to invoke the provisions of 35 U.S.C. § 112 (f). Moreover, even if the provisions of 35 U.S.C. § 112 (f) are invoked to define the claimed inventions, it is intended that the inventions not be limited only to the specific structure, material or acts that are described in the preferred embodiments, but in addition, include any and all structures, materials or acts that perform the claimed function as described in alternative embodiments or forms of the invention, or that are well known present or later-developed, equivalent structures, material or acts for performing the claimed function.

### BRIEF DESCRIPTION OF THE DRAWINGS

A more complete understanding of the present invention may be derived by referring to the detailed description when considered in connection with the following illustrative figures. In the figures, like reference numbers refer to like elements or acts throughout the figures.

FIG. 1A-1D schematic diagrams of a first embodiment of the air dryer, in which FIG. 1A is a schematic illustration of components thereof in a side elevation view, whereas FIG. 1B is a side elevation of the nozzle in FIG. 1A, FIG. 1C is a top plan view of the first embodiment, FIG. 1D is a side elevation view of the housing in FIGS. 1A and 1C, and FIG. 1E is a bottom plan view of the housing;

FIG. 2 is a schematic perspective of the first embodiment of the air dryer being deployed to dry a flexible bladder;

FIG. 3 is a schematic perspective of the second embodiment of the air dryer being deployed to dry a flexible bladder;

FIG. 4 is a schematic elevation view of the air dryer in a first step of inserting into the opening in the bladder;

FIG. 5 is a is a schematic elevation view after a second step of further inserting of the air dryer in the opening in the bladder after the air dryer has been rotated 90 degrees, which further illustrates the directions of the air flow when the fan is energized;

FIG. 6 is a perspective exploded view of the components of the second embodiment;

FIG. 7 is a bottom plan view of the second embodiment showing the opening of the bladder at section line A-A in FIG. 5;

FIGS. 8A and 8B are orthogonal exterior elevations view of the second embodiment;

FIGS. 9A and 9B are respectively front to side and back to side perspective views of the device used to open the tube/port for connection of the hose used for drinking;

FIGS. 10A and 10B are orthogonal exterior elevations view of a third embodiment.

FIG. 11 is an exploded perspective view of the embodiment of FIG. 10A-B;

FIG. 12A is a sectional elevation of the nozzle of a fourth embodiment and FIG. 12B an exterior elevation view thereof;

FIGS. 13A and 13B are orthogonal exterior elevations view of the fifth embodiment;

FIG. 14A-14C illustrate an alternative embodiment of the nozzle in which FIG. 14A is a top plan view and FIGS. 14B and 11C are orthogonal exterior elevations views;

FIG. 15A-B schematically illustrate an alternative embodiment of the drying with preferred embodiment of the nozzle using an alternative embodiment of the fan in which FIG. 15A is an exterior elevation view and FIG. 15B is a sectional elevation of the nozzle with a partial cut away view of the housing showing the fan, fan blades, motor and a battery, and battery charging port;

FIG. 16 is a perspective view of a bladder with a rigid circular rim as the opening for filling with water;

FIG. 17 is a side elevation view illustrating an embodiment of the dryer configured to hang from the bladder of FIG. 16;

FIG. 18 is a side elevation view illustrating an alternative embodiment of the dryer that supports the bladder in FIG. 16;

FIG. 19A is a rear perspective view of an alternative embodiment of a housing for the dryer motor, whereas FIG. 19B is a side elevation view of an embodiment of the nozzle deployed with a fan in the housing and the nozzle extending upward;

FIG. 20 is side elevation view of an alternative embodiment of the dyer deploying the housing of FIG. 19A-19B with an alternative embodiment of the nozzle to dry a storage bag;

FIG. 21 is an isometric view of another embodiment of electric dryer for a bladder or food storage bag in accordance to one or more embodiments;

FIG. 22 is an side view of another embodiment of electric dryer for a bladder or food storage bag in accordance to one or more embodiments;

FIG. 23 is an isometric view of another embodiment of electric dryer for a bladder or food storage bag in accordance to one or more embodiments;

FIG. 24a is a back view of another embodiment of electric dryer for a bladder or food storage bag in accordance to one or more embodiments;

FIG. 24b is a cross-sectional view of FIG. 24a of another embodiment of electric dryer for a bladder or food storage bag in accordance to one or more embodiments;

FIG. 25 is an isometric exploded view of another embodiment of electric dryer for a bladder or food storage bag in accordance to one or more embodiments;

FIG. 26a is an exploded back view of another embodiment of electric dryer for a bladder or food storage bag in accordance to one or more embodiments; and

FIG. 26b is an exploded cross-sectional view of FIG. 26a of another embodiment of electric dryer for a bladder or food storage bag in accordance to one or more embodiments.

Elements and acts in the figures are illustrated for simplicity and have not necessarily been rendered according to any particular sequence or embodiment.

### DETAILED DESCRIPTION

In the following description, and for the purposes of explanation, numerous specific details are set forth to provide a thorough understanding of the various aspects of the invention. It will be understood, however, by those skilled in the relevant arts, that the present invention may be practiced without these specific details. In other instances, known structures and devices are shown or discussed more generally to avoid obscuring the invention. In many cases, a description of the operation is sufficient to enable one to implement the various forms of the invention, particularly when the operation is to be implemented in software. It should be noted that there are many different and alternative configurations, devices, and technologies to which the disclosed inventions may be applied. The full scope of the inventions is not limited to the examples that are described below.

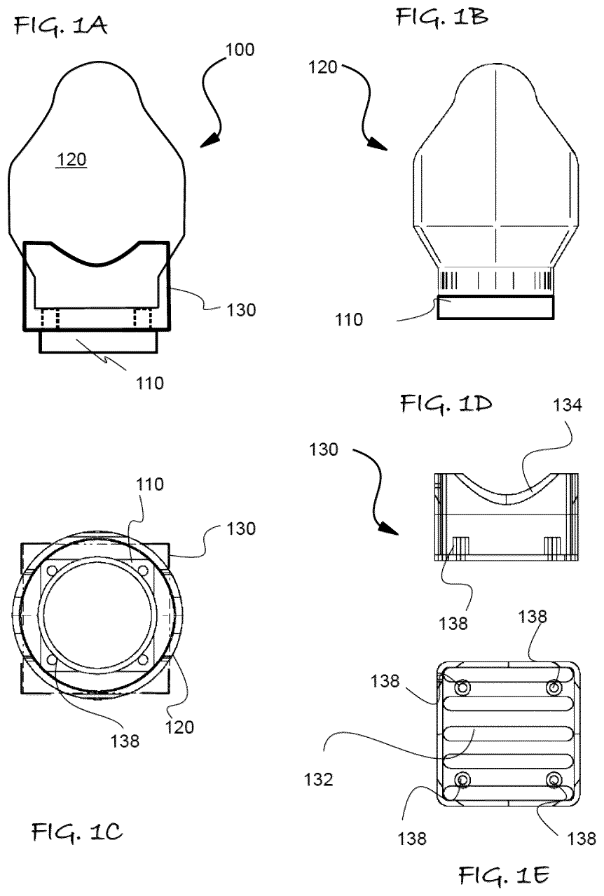

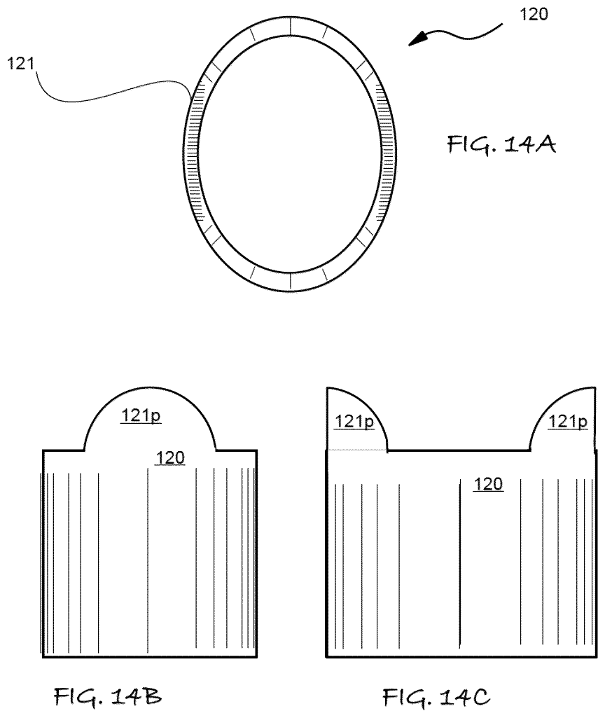

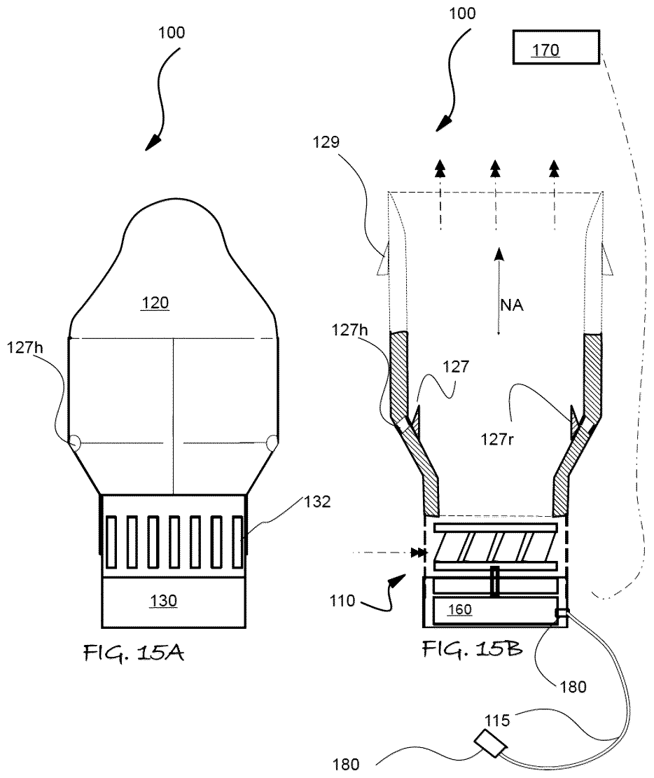

Referring to FIGS. 1A through 20, wherein like reference numerals refer to like components in the various views, there is illustrated therein a new and improved Air Dryer and method of use, generally denominated 100 herein.

In accordance with certain aspects of the present innovations the air dryer 100 may comprise an electric fan 110 and a nozzle 120 to connect to the output 112 of the fan 110 for insertion in a filling portal or opening 11 of a bladder 10 configured for the carrying and dispensing potable water. The inventor has come to appreciate that an efficient way to dry any pliable bladder 10 is by positioning the bladder 10 so the filling portal or orifice is to provide an opening 11 below the other parts of the bladder, so gravity will aid in directing water droplets downward to the opening. Depending on the bladder 10 type the nozzle 120 may be configured to be retained in the bladder opening 11 when the bladder is suspended from the opposing end to drain water forward the opening 11.

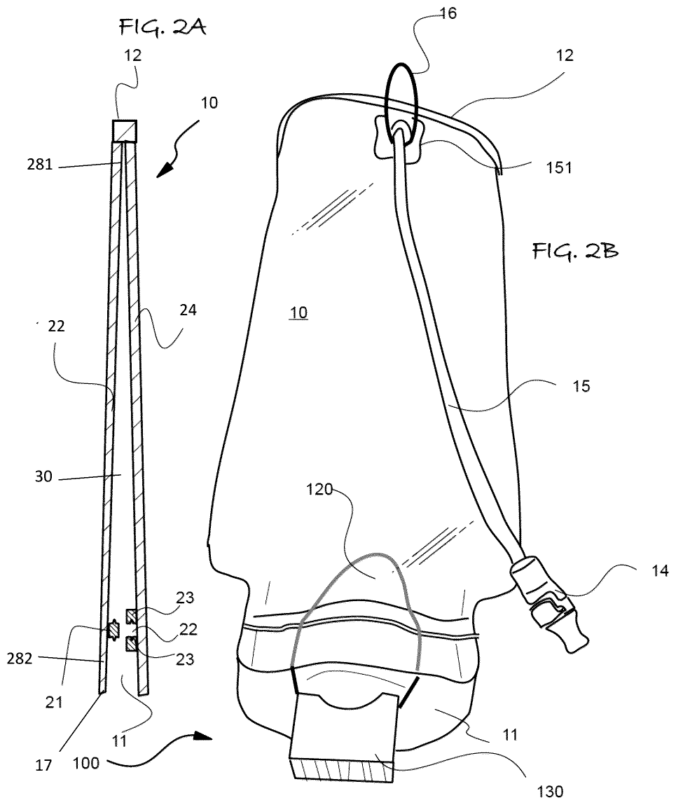

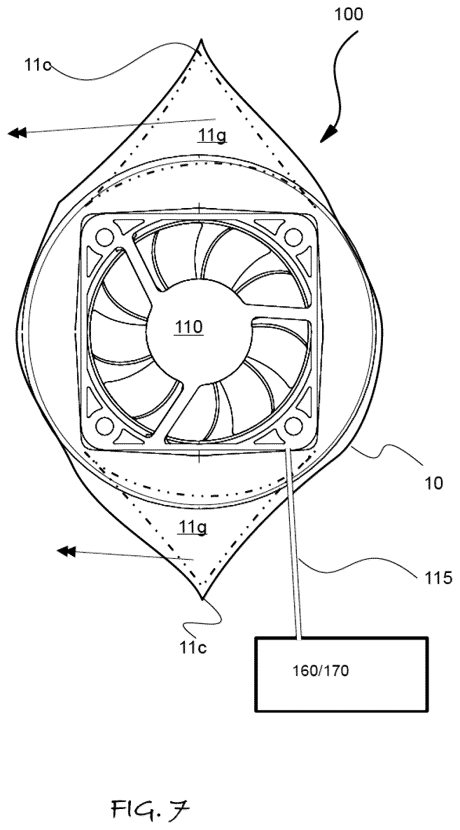

In one embodiment illustrated in FIG. 2A-B, the bladder 10 has an opening 11 at the bottom edge of the front panel 26 and back panel 28. The nozzle 120 may have a larger width at the upper rim 121 that are adapted to closely fill the majority of the opening 11 which is generally circular to oval with a pair of opposing pointed edges 11 to present bowed shape on each opposing side as illustrated in FIG. 7. The nozzle has a lower rim 122 that is in fluid communication with the fan 110. The sides or sidewall 123 of the nozzle 120 between the upper rim 121 and the lower rim 122 are configured to facilitate entry into the opening 11 and engage the front panel 26 and back panel 28 of the bladder 10 adjacent to the opening 11 to be retaining therein when the bladder 10 is hanging from the top 12 with the opening 11 pointing downward.

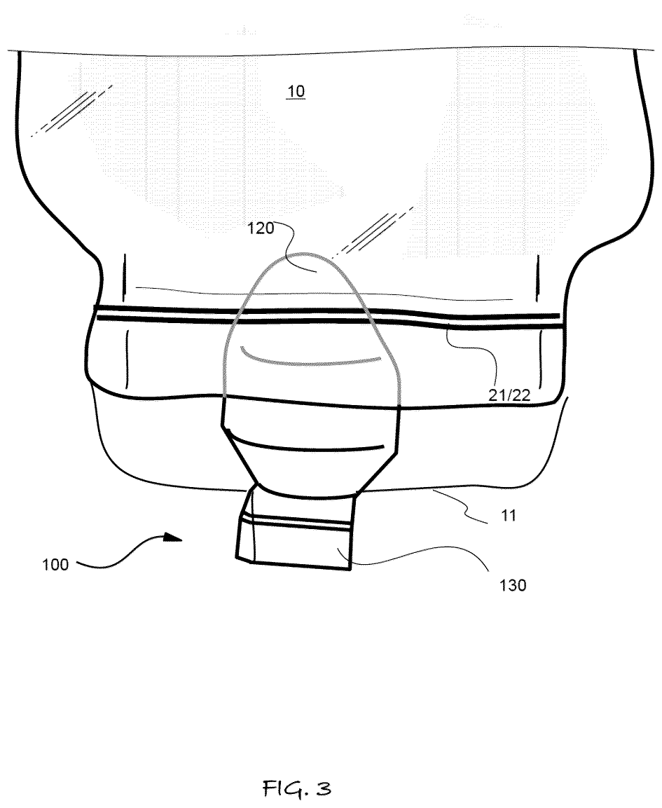

The inventor has discovered that very small fans 110 can be used when a bladder 10 is hung from the top 12, and the dryer 100 can actually be supported within the bladder 10 as illustrated in FIG. 2-3, among others.

The nozzle 120 is preferably shaped to project a sufficient distance into the bladder 10, usually at least about an inch or 23 mm, to enable a sufficient pattern and distribution of air flow, indicated in various embodiment with double headed arrows, to dry the interior of the bladder sufficiently, while being engaged within the opening 11.

The bladder 10 can be hung from an end opposite the filling portal 11 or from the nozzle 120 or fan base 139 so the end or top 12 of the bladder 10 opposite the filling portal 119 is positioned to drain water toward the filling portal 11. In some embodiment the electric fan 110 and housing 130 are substantially within a lateral projecting envelope of the portion of the nozzle 120 inserted in the filling portal 11 of the bladder 10 and the nozzle 120 is configured to engage the bladder 10 to retain the electric dryer 100 in fluid communication for air flow into the bladder 10 when the bladder 10 is hanging with the intake portal or opening 11 below upper portions of the bladder 10.

In certain embodiments, such as in FIGS. 2-3, 5 and 17 the frictional engagement at the vertical portion of the nozzle sidewall 123 may be sufficient to engage the dryer 100 when the bladder 10 is hanging from the top, with the opening 11 facing downward.

In certain embodiment the sidewall 123 of the nozzle 120 can frictionally engage the region of the opening 11, such as an adjacent channel 22 or track 21 that are configured to seal the opening 11 when the bladder 10 is filled with water.

It should be appreciated from reference to FIG. 7 that the opening 11 is generally bow shaped when manually opened, the elastic restoring forces of the distorted adjacent portion of the front panel 26 and 10b act to close the opening 11. Any vertical of the sidewall 123 or the inward tapering portion and frustoconical portion 123a may engages the bowed opening, as gravity acting on the combined mass of the dryer 100 counteracts this force. However, if the dryer 100 where to slide farther down from the opening the perimeter of the inward taper engaging the front panel 26 and back panel 28 would increase the retaining force asserted by the bowed opening trying to close.

Alternatively, in some embodiment with an inward tapering portion 123a may facilitate supporting heavier dryers 100 to reach an equilibrium position in which the upper rim 121 penetrates into the bladder 10 a sufficient distance to facilitate the drying rate.

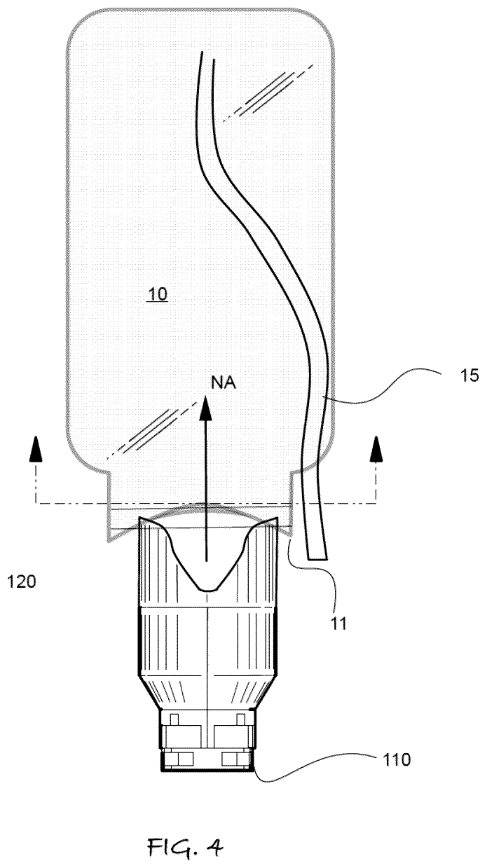

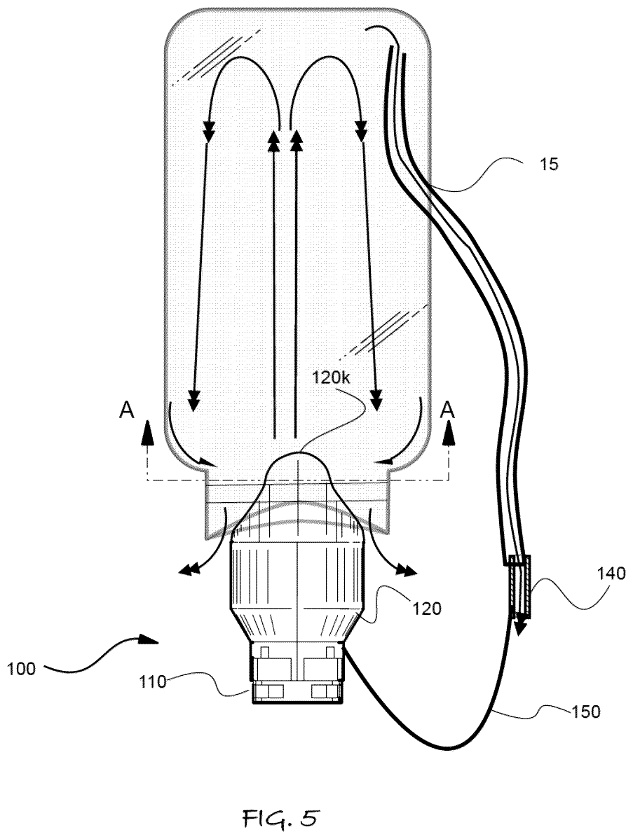

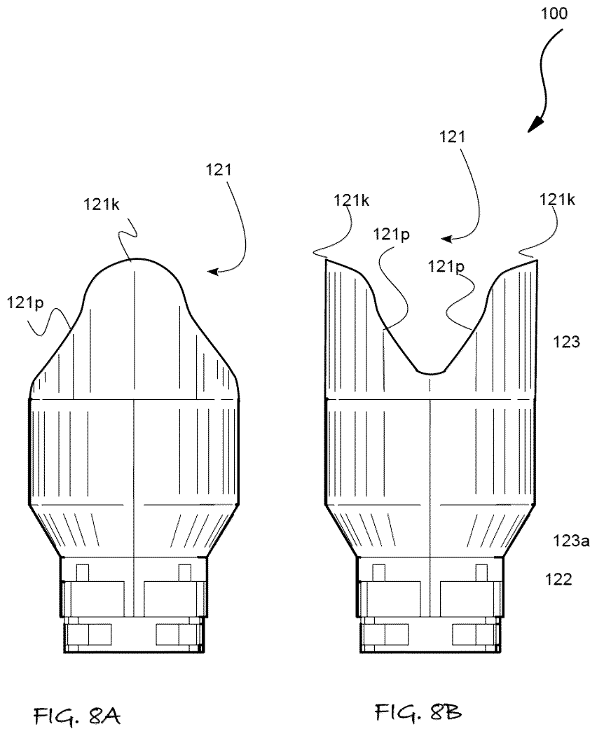

The opening of the nozzle 120 at upper rim 121 it is preferably configured to facilitate entry into the bowed shape opening 11 illustrated of the bladder as illustrated in FIG. 7. The opening has two opposing corners 11c where the front panel 26 and back panel 28 of the bladder are joined. Rather that all portion of the upper rim 121 being co-planar, there are a pair of curvilinear projections 121p that extend to peaks 120k from a generally circular or oval perimeter separated by 180 degrees about a center of the nozzle 120, as illustrated in the orthogonal side elevations in FIG. 8A-10B, among others. It is easier to insert the nozzle rim 120 into the opening when the peaks 120k are adjacent the opposing corner 11c, as shown in FIG. 4, as compared with a nozzle 120 with a flat or fully co-planar upper rim 121. Once the nozzle 120 is partly inserted in the opening 11 it can be further enlarged by rotating the nozzle 120 90 degrees about the principal axis (arrow NA) after which the nozzle 120 is further inserted to about the position shown in FIG. 5. The nozzle 120 at the peak 120k of the upper rim 121 now preferably extends about 1 inch beyond the opening 11. The shape of the portions of the nozzle 120 beyond this perimeter of the projection can continue to be curvilinear or remain in the plane orthogonal to the principal axis of the circular base. Method of use of the dryer 100 may include inserting the nozzle 120 in the portal and then rotating to nozzle and/or fan 90 degrees before further insertion.

The more preferred shapes of the nozzle 120 results when inserted into a pliable opening 11 will result in opposing gaps 11g at the generally triangular bowed edges of the opening 11. These gaps 11g allow for water to be expelled and the air forced into the bladder 10 by the dryer 100 to escape, as illustrated in FIG. 7.

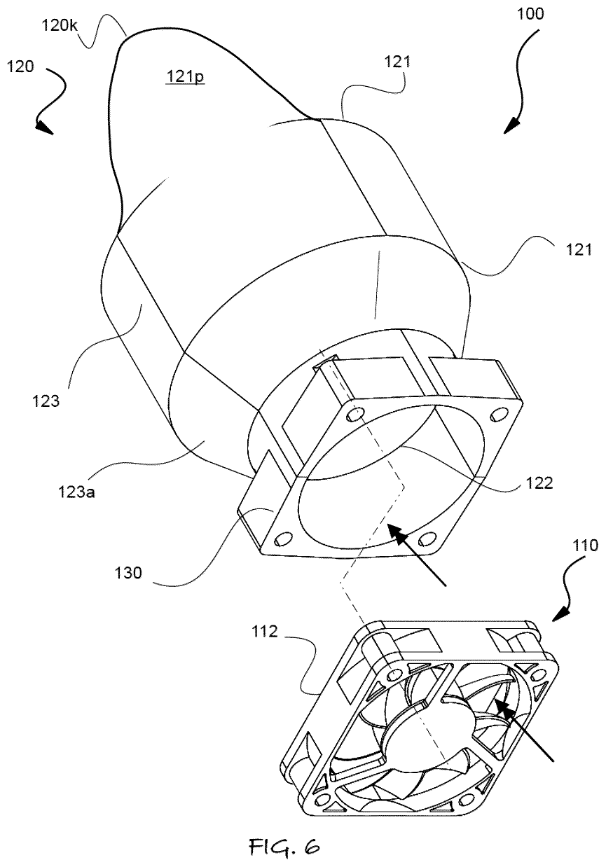

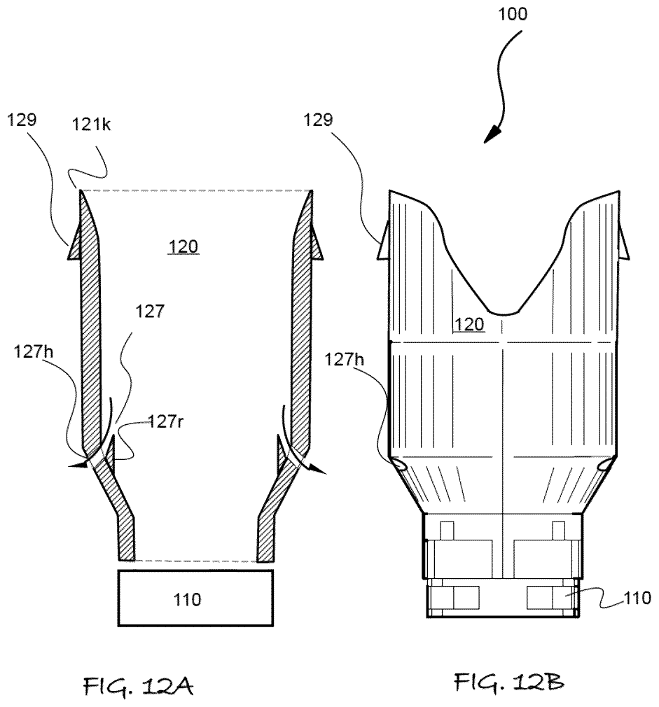

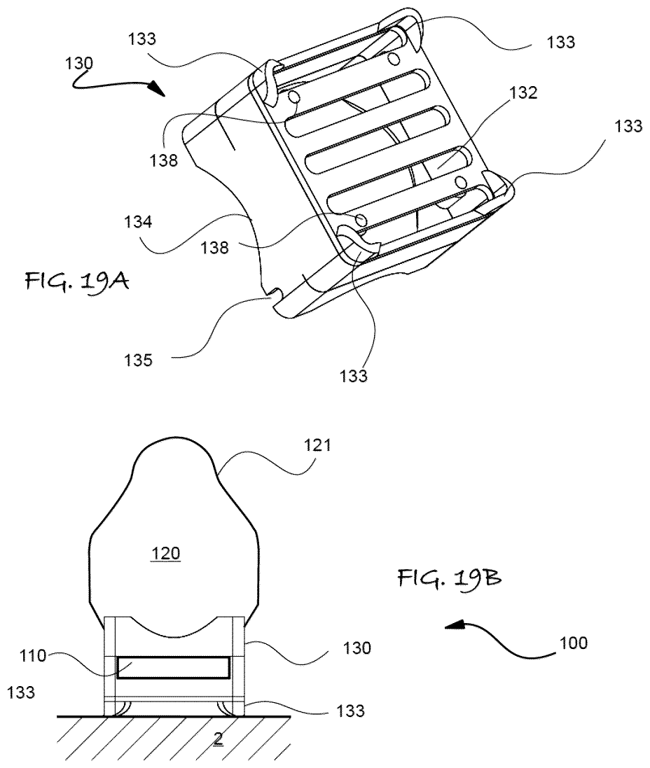

Other aspects of the innovations may include a housing 130 for the electric motor and fan blades that form the fan 110. FIGS. 6 and 11 are exploded views of embodiments showing how the nozzle 120 and fan 110 may be coupled with the fan captured with the housing 130. The base of the nozzle 120 in FIG. 11 may have a series of threaded holes or nut supporting recess to receives screws that extend through the corner of the fan 110 via the holes 138 in the base of the housing 130. Such a housing 130 also preferably includes a safety grating with holes or slits 132 on the air intake side, as illustrated in FIG. 1D and FIG. 11. FIGS. 11 and 19A also illustrate that an upper rim 134 of the housing 130 may be shaped to accommodate the frustoconical shaped portion 123a of the nozzle 120, having concave recesses between each of the 4 corners. The upper rim 134 may also have a notch 135 to allow unrestricted egress for a power or signal cord 115 to the motor of the fan 110.

In the more preferred embodiments, the electric fan 110 and base or interface portion of the nozzle 120 that provide the coupling for the fan 110 to force air into the nozzle 120 are substantially the same lateral dimensions of the portion of the nozzle 120 for insertion in the opening 11. The housing 130 may also have flush or threaded holes 138 to accept screws that connect to mating holes in an electric fan 110 housing. The various embodiments of the dryer 100 may use several alternative power source or cord 115 to energize the motor of the electric fan 110. The nozzle 120 and housing 130 can also be configured to engage by a press fits, screw fitting with a single engaging thread on each member, or a bayonet fitting, and the like.

FIG. 5 also indicates the likely air flow pattern by double headed arrows when the nozzle 120 is inserted as described above. The air flows upwards about width of the nozzle 120 before reverting to a downward trajectory to exit at the generally triangular opposing gaps 11g between each opposing corner 11c and the exterior sidewalls 123 of the nozzle 120.

The nozzle 120 is inserted into the bladder 10 a depth sufficient for the air discharged at the rim 121 of the nozzle 120 airflow to first flow upward in the central portion of the bladder 10 over the nozzle 120. This depth is generally at least about an inch, or about 23 mm. However, while some air can flow out the hose 15, a greater volumetric air flow is downward adjacent the interior bladder walls defined by the facing surface of the front panel 26 and back panel 28. The upper air flow being restricted by the nozzles 120 width inflates the bladder 10 separating the front panel 26 and back panel 28 that form the interior walls and thus urge clinging water droplets to drain downward and outward through the gaps 11g.

Further, it is preferable to also provide with or as part of the dryer 100, such as in a kit, and included a drain knock or tubular member 140, allows the port 14 to be opened to allow for airflow and allow the water within the drinking tube or hose 15 to drain and remove fluid. Hence, the drain knock or tubular member 140 includes a tubular portion 143 with a handle portion 141 for retaining open a valve or port 14 in the fluid delivery hose 15, which allows fresh air blown in through the nozzle 120 to run through the hose 15 to remove water droplets and absorbed moisture. This preferred pattern of air flow direction is into the bladder 10 promotes inflation so water does not cling to opposing sides in a collapsed bladder 10 and insertion of a frame into the bladder 10 is not required.

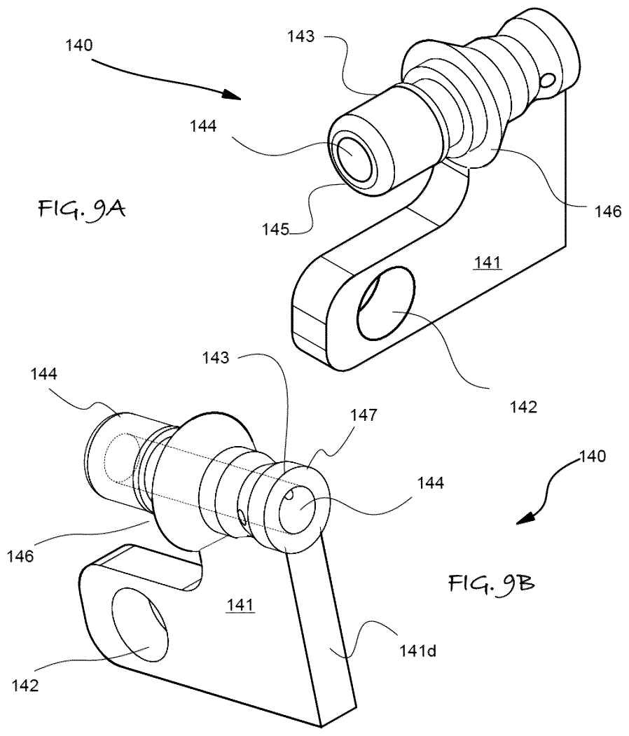

A tether 150 may be deployed connecting the drain knock or tubular member 140 to the dryer 100, such as at the housing 130, fan 110 or a basal portion of the nozzle 120, as schematically illustrated in FIG. 5. An embodiment of the tubular member 140 is also illustrated at a larger scale in front and rear perspective view in FIG. 9A-9B in which the tether 150 can extend as a loop through a hole 142 in a planar base of the handle 141 that extends downward from the tubular portion 143. The tether 150 is preferably elongated and flexible to optimally position the tubular member 140 the valve end of the hose 15 when it is hanging down from adjacent a top of the bladder 10. The tubular portion 143 has a central open channel 144 with the cylindrical proximal end 145 intended to be insert into the mouth delivery portion of hose 15, to open a valve 14 thereof such that air from the dryer 100 can pass through via the central open channel 144. An annular flange 146 about the exterior of the tubular portion 143 may be deployed to limit the depth of insertion into the hose 15 to that necessary to open the valve, and thus avoid excess insertion that may make extraction after use more difficult or permanently distort the valve to detrimentally damage the function thereof. As the distal end 141d of the planar base 141 is flush with the distal end 147 of the tubular portion 143, the distal end 147 cannot be insert by mistake into the hose 15. The frustoconical shape of the reverse side of the flange 146 and annular ridges between the flange and the distal end 147, along with the flat shape of the planar portion 141 and distal ends 141d aid in the gripping of the tubular member 140 with the finger to insert the proximal end fully into the hose 15 up to the flange 146.

The fan base 130 or nozzle 120 may deploy other projections like the barbs 129 to retained in the opening 11 when the bladder 10 is hanging from the top 12 with the portal facing downward, such as the angle protruding rim 129B on an upper portion of the 120p.

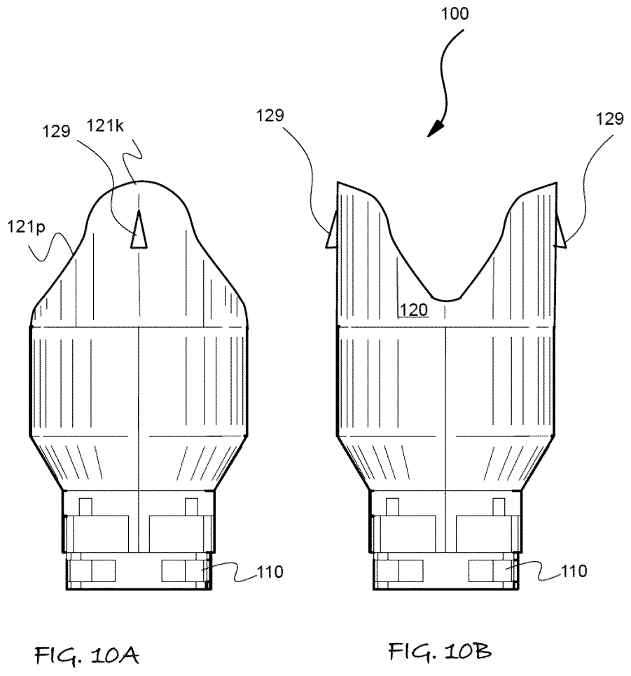

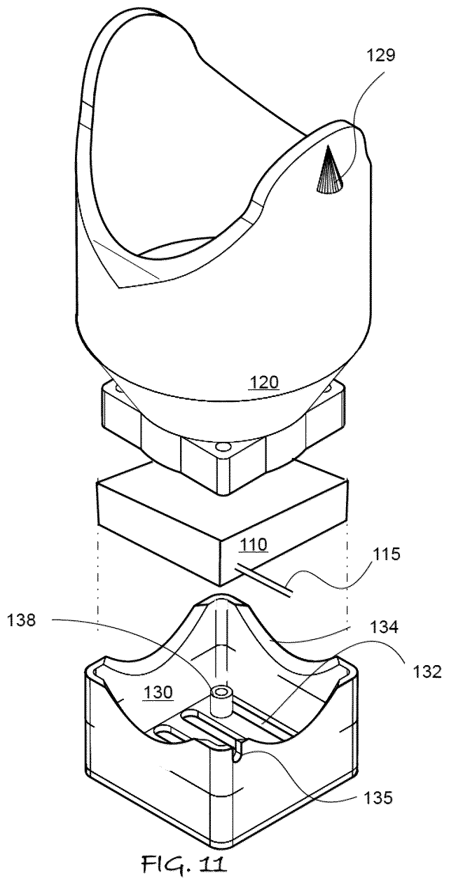

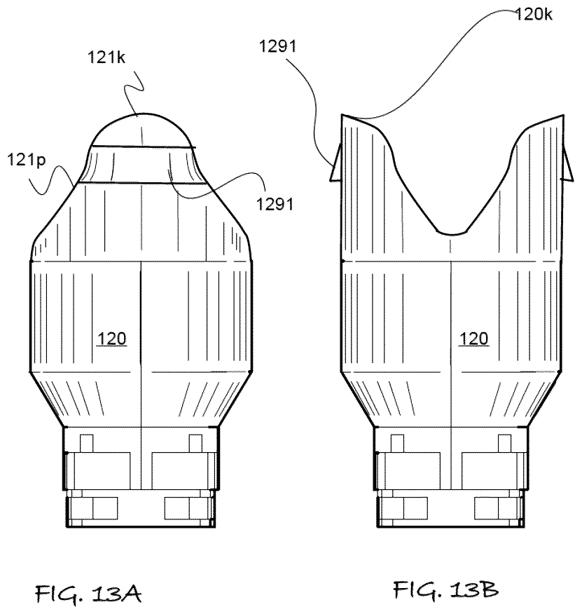

Additional features, in addition to or in place of the isolated barbs 129 below the rim peaks 120k, are illustrated in FIG. 10A-11B. The use of the two opposing barbs 129 allows an air dryer 100 of approximately 2 lbs. 7 oz (1,104 gm) to still be retained in the opening 11, as compared to a maximum air dryer weight of approximately 1 lb. 14 oz (846 gm) for the same embodiment without the barbs 129. The barbs 129 may be replaced by an extending or continuous flange 1291 (in FIG. 13B) about an upper or other sidewall portion 124 of the nozzle 120. The flange 1291 may operatively supporting the dryer 100 in the opening 11 of the bladder 10 such that liquid water droplet on the interior of sides the front panel 26 and back panel 28 and 20b will flow down to the entrance 11.

FIGS. 10A and 10B also illustrate another embodiment of the dryer 100 in which the nozzle 120 may include an interior annular channel 127 about insertion side wall 123 of the nozzle 120 to collect water. The bottom of the channel 127 has holes 127h that drain the water to the exterior of the nozzle 120, fan 110 and housing 130. This may prevent water drops from penetrating the motor and electronic assembly of the fan 110. The channel 127 defined by the space between the interior of the nozzle sidewalls 123 and an interior upward annular projection 127r from the sidewalls 127.

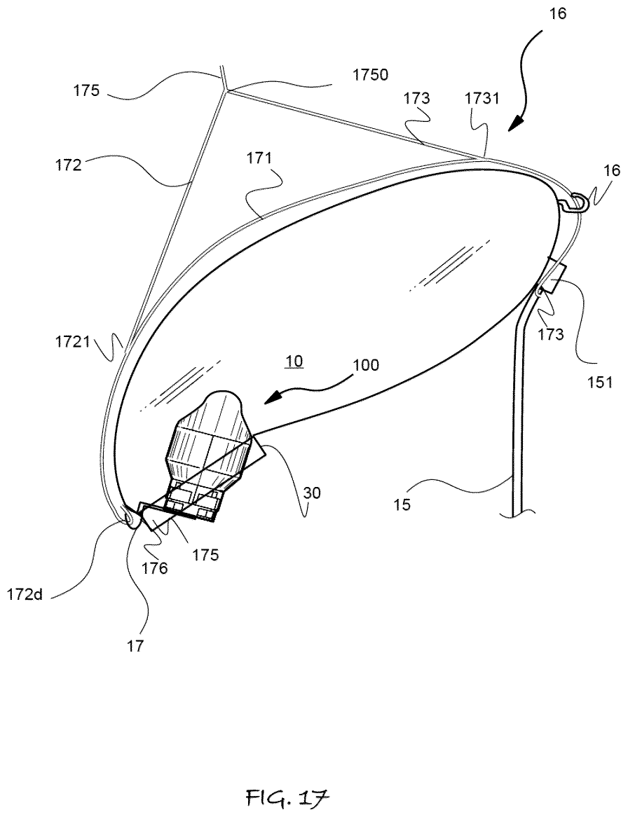

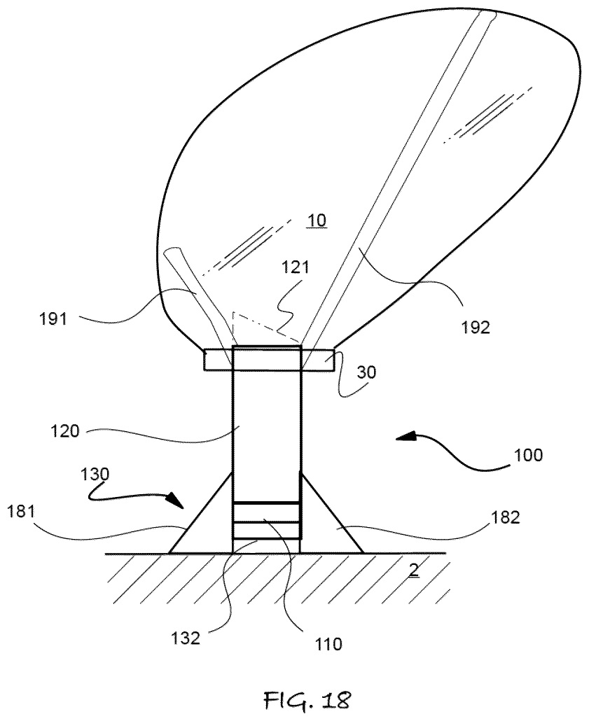

The dryer 100 may also be used with the nozzle 120 inserted within the rigid rim 19 of a side portal 11 of the bladder 10 in FIG. 16 with the bladder 10 oriented as in FIG. 17-18. When the bladder 10 is inflated as in FIGS. 17 and 18 interior side maintains a smooth surface downward directed so water does not collect while draining, but rather flows out of the opening 11.

Bladders 10 frequently include a hanger 16 as part of the system that allows for the device to hang when the bladder is linear with the opening on the end. The electric fan 110 should provide a volumetric flow rate that is high enough so that any leakage at the portal 11 and nozzle interface at gaps 11g does not preclude inflation of the bladder 10 and flow of air through the opened fluid delivery hose 15. For example, for Osprey brand bladders 10 this is at least about 3.0 CFM.

In the embodiment of the FIG. 17 the bladder 10 is hung by any combination of straps 171, 172 and 173, with strap 173 extending around the base 151 and/or hose 15 for connecting the hose 15 to the bladder 15, rather than hanging hook 16. The distal end 172 of strap 171 or 172 connects to the lower hook 17 below the rigid rim, and the straps 172 and 173 may be fixed in length joining at position 1750 to a single hanging member 175 to tilt all sides of the bladder 10 to drain downward to the rear of the rigid rim 30. The dryer 100 may be disposed as shown with the nozzle 10 inserted in the opening and titled to contact the front of the rim 30 that is above a rear portion of the rim 30 adjacent the lower hook 17. The bottom of the housing 130 may have an armature 175 with a downward extending segment 176 that engage the interior of the rim 30 adjacent the lower hook 17, thus stabilizing the position of the dryer 100. Strap 171 may extend between the junctions 1731 and 1721 to the upper straps 173 and 172, respectively.

A flat external side of the housing 130 may have features to support the bladder 10 upright without blocking the air intake holes of the protective screen or grate 132 when the housing is disposed on a flat surface 2.

As illustrated in FIG. 18, the dryer 100 has a cylindrical nozzle 120 that rests on surface 2 via side stabilizing fins 181 and 182, and optionally a third or fourth orthogonal fin, to position the slots 132 in the housing base above the surface 2. The rim 121 of the nozzle 120 extends into the bladder 10 via the rigid opening 30 and may deploy arms 191 and 192 that support the interior of the bladder 10 to orient it for drainage as in FIG. 17, but avoid hanging the bladder 10, such as by the straps in FIG. 17. The arms 191 and 192 are preferably attached to the nozzle 120 outside the rim 121 to avoid acting as wicks of droplets into the fan 110. Arms 191 and 192 may be coupled to a common ring or fixture that attaches over the exterior of the sidewalls 123 of any of the various embodiment of the nozzle 120 that have been described herein, as well as their equivalents.

As illustrated in the embodiments of FIGS. 7, 13A-B and 15B, a source of power to energize the electric fan 110 is one of a DC power source, including a charging base at accepts a USB or functionally equivalent plug or socket 180, a battery 160 and one or more photovoltaic cells 170 that one of directly energize the fan motor and/or recharge the battery via cord 115.

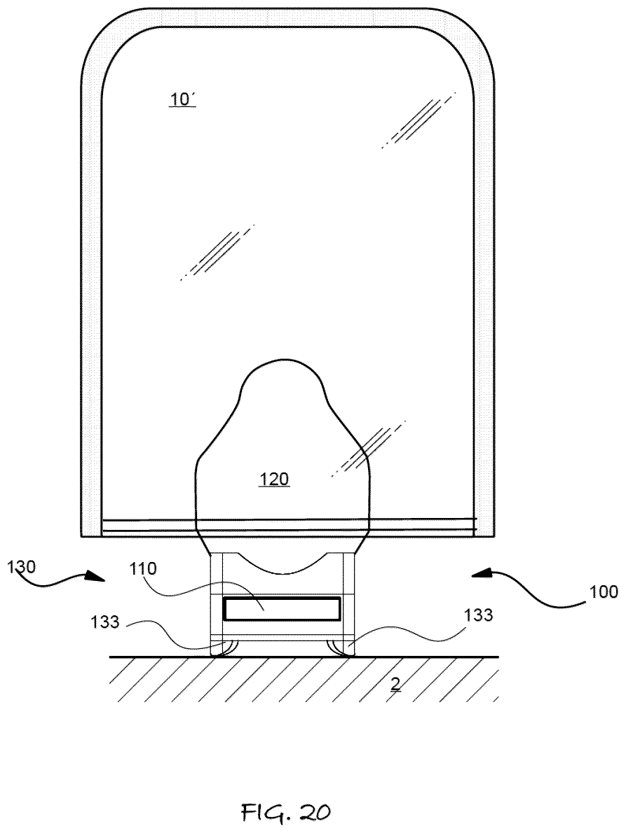

FIG. 19A-20 illustrate another embodiment of the housing 130 configured for being disposed on a flat surface in which a series of four extending feet or bumps 133 about each corner on the bottom having the safety grating 132 on the air intake side, thus supporting the air intake side above the supporting surface 2.

In FIG. 20 an alternative embodiment of the nozzle 120 is deployed to support a food storage bag 10′ with a mating track 21 and channel 22 closure at the opening 11. While such food storage bags originated as disposable contains made of polyolefin films, such bags made of tough silicone sides the front panel 26 and back panel 28, that are sealed together like a bladder 10, have become more prevalent because they can withstand higher temperatures for cooking, such as in the microwave or a water bath in sous vide cooking, and though more expensive are reusable. However, reuse requires cleaning and then careful drying, which is achieved with various embodiment of the nozzle 120 illustrated and/or described with respect to this and other Figures in the application. Thus, the embodiment of the dyer 20 can rest on a surface 2 and support smaller bags 10′ as they dry, as well as hang from the opening 11 in a hanging bladder 10.

The portability of an electric air dryer 100 can be enhanced when configured and used in the various preferred embodiments to most efficiently use available power to expel water droplets, but also provides an efficient air flow pattern to dry the internal surface of moisture. Increased efficiency allows smaller power sources to be used and minimizes the need to replace or recharge small batteries 160 or allows the use of smaller PV cells 170.

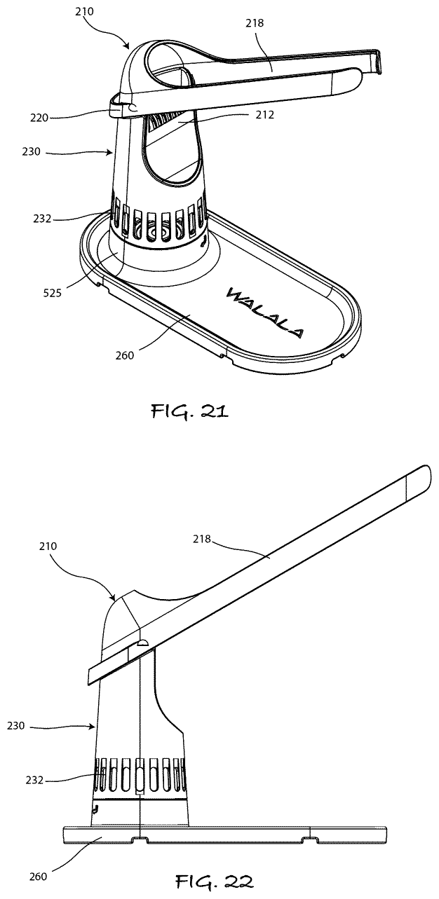

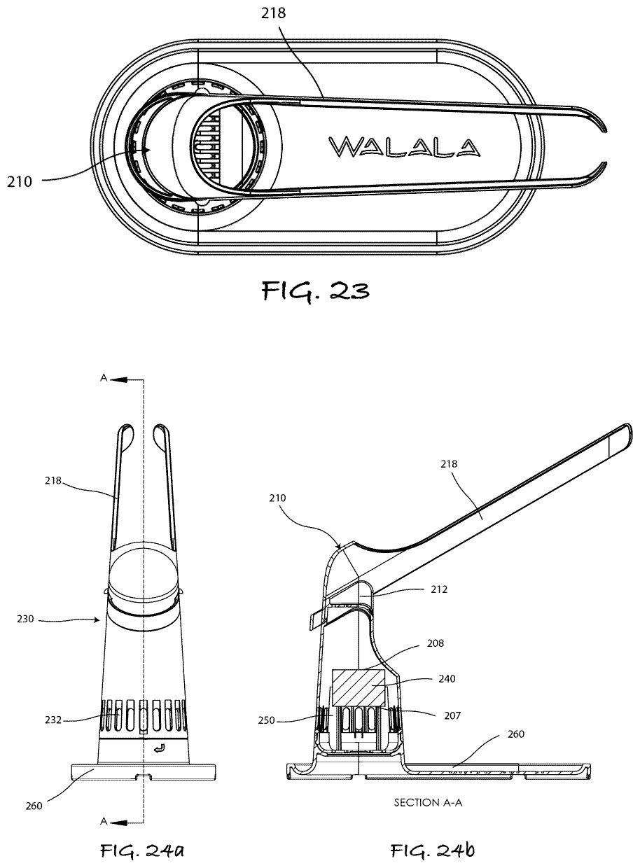

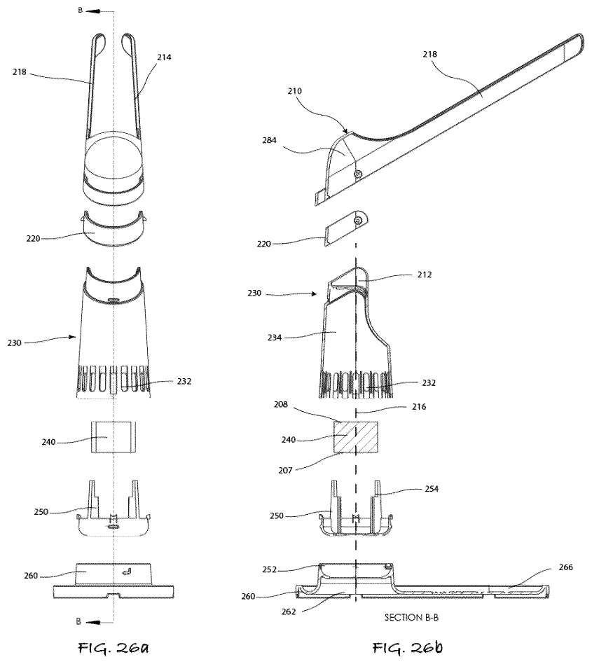

Referring to FIG. 21-26b in an alternative embodiment of an electric dryer 200 for a bladder 10 or food storage bag, the bladder or food storage bag having an opening at a top side 12, a bottom side 17 opposite the top side and a longitudinal axis running from the top side to the bottom side, a front panel 26, and a back panel 28 at least partially defining an internal volume 20, as shown in FIG. 2A, the electric dryer comprising an electric fan 240 having an intake side 207 and an output side 208. A housing 230 that can at least partially enclose the electric fan 240, the housing having a fan base 250 in which the fan is secured and an insert 210 on the output side 204 of the fan.

The fan base 250 can have a fan mount 254 which the fan 240 can be mounted allowing the air to flow. The fan base 250 can be inserted into the safety grating 232 side of the nozzle. The fan base 250 can elevate the fan 240 above the safety grating 232 allowing the air to flow through the intake side 207 and out the output side 208. The fan base 250 can have a plurality of holes at or near the bottom of the fan base to allow air to flow freely into the intake side 207 of the fan 240. The fan mount 250 can have at least one leg 252 that can be integral to the fan mount which can allow the fan to sit partially within the fan base at a height wherein the height can be such as, for example, at least 0.125 inches to at least 5 inches.

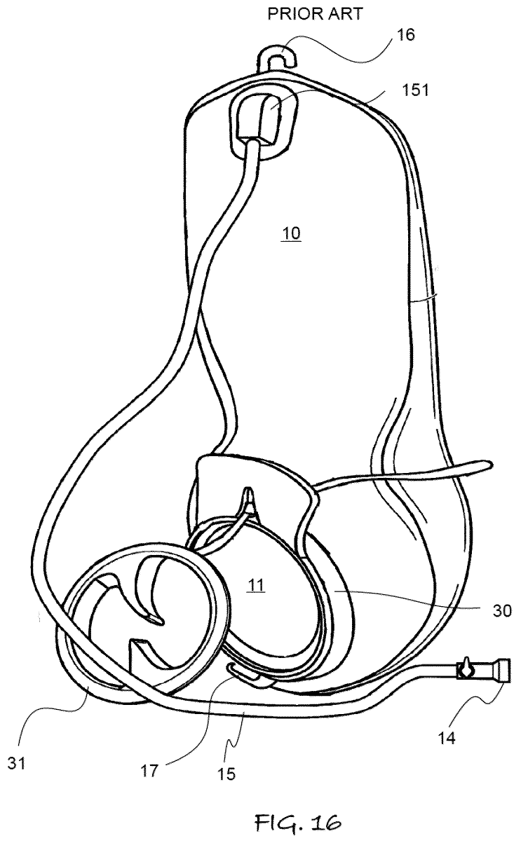

A power line can be coupled to the electric fan 240 to provide power to the electric fan wherein the power line can be a USB or functionally equivalent plug or socket 180 configured to couple to a wall outlet, or a battery 160 as shown in FIG. 15B. The insert 210 can comprise a nozzle 212 through which air from the fan 240 can pass into the internal volume 30 of the bladder 10, as shown in FIG. 2a, when the insert is inserted and the fan is on and wherein the insert is dimensioned to be inserted into the opening and at least partially separate the front panel 26 from the back panel 28 when the insert 210 is inserted into the opening 11 and to support the bladder 280 or food storage bag from folding along the longitudinal axis.

The fan 240 can be configured to move such as, for example, between five and twenty-five cubic feet of air per minute and in other embodiments one and fifty cubic feet of air per minute or in other embodiments can move more than fifty cubic feet of air per minute. At four or five cubic feet per minute, the bladder can be dried in about an hour. At seven or eight cubic feet per minute, the bladder can be dried in about half an hour. The amount of air moved by the fan can be calibrated along with the air temperature and size of the fan to fit a desired dry time. The insert 210 can be such as, for example, semi-rigid or rigid. The insert 210 can be manufactured from such as, for example, plastic, rubber, metal, composite, or the like. The insert 210 can further comprise a projection 218 that can prevent the bladder or food storage bag from being blown off of the insert. The insert 210 can be shaped to project at least an inch into the bladder 280 when the insert is inserted. The projection 218 can be at least one prong but in the preferred embodiment the projection is two prongs with a bend on each end.

The insert 210 has an axis 216, the electric dryer 200 can further comprise a base 260 to which the housing 230 is secured. At least one projection 218 can extends at an angle to the axis of the insert. The angle can be such as, for example, between 110 and 140 degrees and in certain embodiments can be between 40 and 180 degrees. The projection 218 can have a dome shaped top 284 at the nozzle to direct air flow through the nozzle wherein the dome shape can allow for the air to flow efficiently from the fan into the bladder or bag and minimizes the loss of air flow from the fan to the bladder. In certain embodiments, the dome shaped top 284 can be such as, for example, hemispherical, segmental, catenary, faceted, ellipsoidal, or the like.

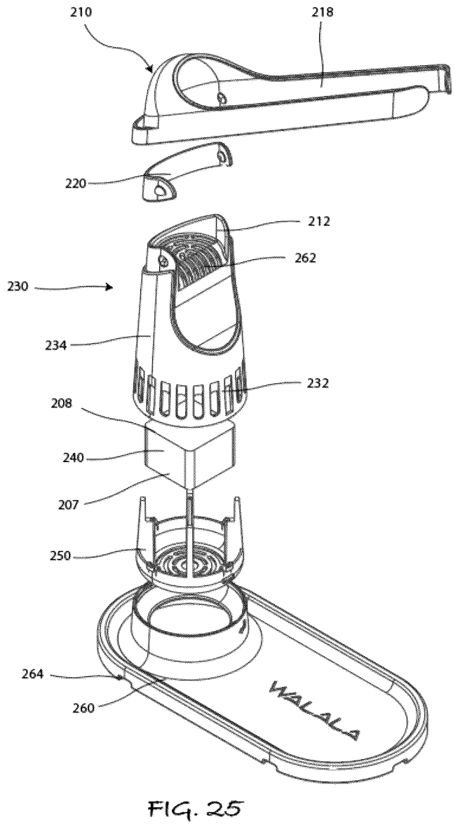

In embodiments, the housing 230 can include at least one inlet on the intake side 207 of the fan 240 that allows air into the housing when the fan is on. The projection 218 can be removably or permanently attached to the insert 210 and/or the housing 230 can be detachably secured to the base 260. The insert 210 can further comprise a pair of curvilinear projections 218 that form a generally circular or oval perimeter, each projection in the pair being separated from the other by about 180 degrees about a center of the nozzle 212. The insert 210 can have a partial spherical section that directs the air into the bladder 10 from the nozzle 212. The nozzle 212 can have a plurality of grates 262 at the top section of the nozzle which can disperse the air even creating a laminar flow into the bladder 10. The nozzle 212 can be any suitable shape or size and in the preferred embodiment is shown in FIG. 25.

The insert 210 can have a lower inward tapering portion 214. The housing 230 can include a safety grating 232 on the intake side 207 of the fan 240. The safety grating 232 can be such as, for example, a plurality of holes or slots that wrap around the axis of the housing substantially near the intake side 207. The housing 230 and/or fan 240 can be supported on at least one leg 252 on the intake side 207 of the fan 240 that when the housing and/or fan is placed on a surface the at least one leg elevates the fan above the surface. The base 260 can have a first section 252 that has a first hole 262 which can allow the fan base 250 to sit within the first section and allow the air to flow from the base through the first hole 262. The base 260 can have at least one slot 264 spaced evenly or unevenly around the bottom perimeter of the base. The base 260 can have a platform 266 that can extend away from the housing 230 and provide support to the electric dryer. The fan 240 can be such as, for example, axial fan, radial fan, shrouded fan, piezoelectric fan, blower fan or the like.

A kit for drying a bladder 10, the kit can comprise the electric dryer 200. A tubular member 140 configured to open the valve 14 at an end of a drinking hose 15 in fluid communication with the pliable bladder 10. A flexible elongated tether 150 for connecting the tubular member 140 to the electric dryer 200. The tubular member 140 can comprise a handle 141 with a hole 142 through which the tether 150 may be passed as shown in FIG. 9A and FIG. 9B.

While the various innovations have been described in connection with several preferred embodiments, it is not intended to limit the scope of the invention to the particular form set forth, but on the contrary, it is intended to cover such alternatives, modifications, and equivalents as may be within the spirit and scope of the invention as defined by the appended claims.

In closing, it is to be understood that although aspects of the present specification are highlighted by referring to specific embodiments, one skilled in the art will readily appreciate that these disclosed embodiments are only illustrative of the principles of the subject matter disclosed herein. Therefore, it should be understood that the disclosed subject matter is in no way limited to a particular methodology, protocol, and/or reagent, etc., described herein. As such, various modifications or changes to or alternative configurations of the disclosed subject matter can be made in accordance with the teachings herein without departing from the spirit of the present specification. Lastly, the terminology used herein is for the purpose of describing particular embodiments only and is not intended to limit the scope of the present disclosure, which is defined solely by the claims. Accordingly, embodiments of the present disclosure are not limited to those precisely as shown and described.

Certain embodiments are described herein, including the best mode known to the inventors for carrying out the methods and devices described herein. Of course, variations on these described embodiments will become apparent to those of ordinary skill in the art upon reading the foregoing description. Accordingly, this disclosure includes all modifications and equivalents of the subject matter recited in the claims appended hereto as permitted by applicable law. Moreover, any combination of the above-described embodiments in all possible variations thereof is encompassed by the disclosure unless otherwise indicated herein or otherwise clearly contradicted by context.

I claim:

1. An electric dryer for a bladder or food storage bag, the bladder or food storage bag having an opening at a top side, a bottom side opposite the top side and a longitudinal axis running from the top side to the bottom side, a front panel, and a back panel at least partially defining an internal volume, the electric dryer comprising:
an electric fan having an intake side and an output side,
a housing that at least partially encloses the electric fan, the housing having a fan base in which the fan is secured and an insert on the output side of the fan;
a power line to provide power to the electric fan;
wherein the insert comprises a nozzle through which air from the fan is passed into the internal volume when the insert is inserted and the fan is on and wherein the insert is dimensioned to be inserted into the opening and at least partially separate the front panel from the back panel when the insert is inserted into the opening and to support the bladder or food storage bag from folding along the longitudinal axis.

2. The electric dryer according to claim 1, wherein the fan is configured to move between five and fifteen cubic feet of air per minute.

3. The electric dryer according to claim 1, wherein the fan is configured to move between 5 and 25 cubic feet of air per minute.

4. The electric dryer according to claim 1, wherein the insert is semi-rigid.

5. The electric dryer according to claim 1, wherein the insert further comprises a projection that prevents the bladder or food storage bag from being blown off the insert.

6. The electric dryer according to claim 1, wherein the insert is shaped to project at least an inch into the bladder when the insert is inserted.

7. The electric dryer according to claim 1, wherein the insert has an axis, the electric dryer further comprising:
a base to which the housing is secured;
at least one projection that extends at an angle to the axis of the insert; and
wherein the housing includes at least one inlet on the intake side of the fan that allows air into the housing when the fan is on.

8. The electric dryer according to claim 7, wherein the angle is between 110 and 140 degrees.

9. The electric drying according to claim 7, wherein the projection has a dome shaped top at the nozzle to direct air flow through the nozzle.

10. The electric dryer according to claim 7 wherein the projection is removably attached to the insert and/or the housing is detachably secured to the base.

11. The electric dryer according to claim 1 wherein the power line is configured to couple to a wall outlet or a battery.

12. The electric dryer according to claim 1 wherein the insert further comprises a pair of curvilinear projections that form a generally circular or oval perimeter, each projection in the pair being separated from the other by about 180 degrees about a center of the nozzle.

13. The electric dryer according to claim 12 in which the insert has a lower inward tapering portion.

14. The electric dryer of claim 1, wherein the housing includes a safety grating on the intake side of the fan.

15. The electric dryer of claim 1, wherein the housing is supported on at least one leg on the intake side of the fan that when the housing is placed on a surface the at least one leg elevates the housing above the surface.

16. A kit for drying a bladder, the kit comprising:
the electric dryer of claim 1;
a tubular member configured to open the valve at an end of a drinking hose in fluid communication with the pliable bladder; and
a flexible elongated tether for connecting the tubular member to the electric dryer.

17. The kit of claim 16, wherein the tubular member comprises a handle with a hole through which the tether may be passed.
